(19) United States
(12) Patent Application Publication
(10) Pub. No.: US 2011/0296054 A1
(43) Pub. Date: Dec. 1, 2011

(54) Network Message Transmission

(75) Inventors: Yogesh Hegde, Bangalore (IN); Seth D. Jennings, Austin, TX (US); Roocha K. Pandya, Mumbai (IN); Prashant A. Paranjape, Bangalore (IN)

(73) Assignee: INTERNATIONAL BUSINESS MACHINES CORPORATION, Armonk, NY (US)

(21) Appl. No.: 12/788,907

(22) Filed: May 27, 2010

(51) Int. Cl. G06F 15/16

(52) U.S. Cl. 709/245

(57) ABSTRACT

A method, computer program product, and apparatus for transmitting a message over a network are presented. A processor unit receives the message for transmission over the network and a portion of an address for a source from which the message is to be transmitted. The processor unit identifies an interface configured to transmit messages from the source onto the network using the portion of the address. The processor unit then transmits the message from the source onto the network using the interface.

### BACKGROUND

1. Field

The disclosure relates generally to an improved data processing system and in particular to network communication by a data processing system. More specifically, the disclosure relates to transmitting a message over a network.

2. Description of the Related Art

Protocols are commonly used in the transmission of messages over networks of computer systems. A protocol is a pre-determined set of rules for communicating on the network. For example, the protocol may include rules regarding the type, format, and amount of data transmitted in a particular message that uses the protocol. Examples of protocols include transmission control protocol (TCP), internet protocol version 4 (IPv4), internet protocol version 6 (IPv6), hypertext transfer protocol (HTTP), and file transfer protocol (FTP).

Many computer systems have multiple interfaces connected to multiple networks at the same time. An interface is a hardware device that uses signals to send and/or receive messages on a particular network. An interface allows a computer system to send and receive messages on a network to which the interface is connected.

Each interface that communicates using some protocol is associated with a particular address on the network to which the interface is connected. The address is used to identify the interface on the network from other interfaces on the same network.

For example, IPv4 uses internet protocol addresses (IP addresses) to identify interfaces on a network that uses IPv4. The addresses are a string of 32 bits that is often expressed as four octets of numbers between 0 and 255. For example, an IPv4 address may be expressed as 10.14.20.29. On the other hand, IPv6 addresses interfaces using 128 bits that are commonly expressed as eight groups of four hexadecimal digits. For example, an IPv6 address may be expressed as 2001:0 db8:85a3:0000:0000:8a2e:0370:7334.

In some protocols, an interface connected to a network is referred to as being in a zone. A zone is a topological region of the network to which an adapter is connected. Interfaces connected to networks using particular protocols associate a zone identifier with the interface to represent the zone. The zone identifier is a number selected by the interface and/or the computer system to which the interface is connected that designates that a particular interface is connected to a particular network. Because the zone identifier is selected by the interface and/or the computer system to which the interface is connected, the zone identifier may differ between computer systems connected to the same network.

For example, assume a computer system has three interfaces. Two interfaces are connected to a first network that uses a protocol that supports zone identifiers, and the third interface is connected to a second network that uses a protocol that supports zone identifiers. Two interfaces are connected to the first network to provide support for load balancing between the interfaces. In this illustrative example, the two interfaces connected to the first network would be assigned the same zone identifier, while the third interface would be assigned a different zone identifier. For example, the two interfaces may be assigned a zone identifier of 1, while the third interface is assigned a zone identifier of 2.

Interfaces are assigned zone identifiers because addresses that are in use by interfaces on a particular network may be used by other interfaces on another network. For example, assume a computer system is connected to a first network using a first interface and a second network using a second interface. The address used by the first interface on the first network may be the same as the address used by the second interface on the second network because the two networks are not connected. Thus, addresses may only be unique on a particular network.

Additionally, another computer system connected to the first network may have an interface that uses the same address on the first network as a computer system with an interface that is connected to the second network. Thus, a message generated by an application running on the computer connected to both the first and second network may not reach a desired recipient when the message is transmitted because the application is unaware of which interface the computer system will use to transmit the message

Thus, applications specify a zone identifier representing the network on which the message should be transmitted. The computer system then identifies the interface to transmit the message based on the zone identifier received from the application.

### SUMMARY

A method, computer program product, and apparatus for transmitting a message over a network are presented. A processor unit receives the message for transmission over the network and a portion of an address for a source from which the message is to be transmitted. The processor unit identifies an interface configured to transmit messages from the source onto the network using the portion of the address. The processor unit then transmits the message from the source onto the network using the interface.

### BRIEF DESCRIPTION OF THE SEVERAL VIEWS OF THE DRAWINGS

FIG. 1 depicts an illustration of a network of data processing systems in which illustrative embodiments may be implemented;

FIG. 2 depicts an illustration of a data processing system in accordance with an illustrative embodiment;

FIG. 3 depicts an illustration of a network environment in accordance with an illustrative embodiment;

FIG. 4 depicts an illustration of an Open System Interconnection (OSI) model in accordance with an illustrative embodiment;

FIG. 5 depicts an illustration of a desired scope in accordance with an illustrative embodiment;

FIG. 6 depicts an illustration of an input that causes a message to be generated by a computer system in accordance with an illustrative embodiment;

FIG. 7 depicts an illustration of a listing of interfaces in accordance with an illustrative embodiment;

FIG. 8 depicts an illustration of a set of collections of interfaces in accordance with an illustrative embodiment;

FIG. 9 depicts a flowchart of a process for transmitting a message over a network in accordance with an illustrative embodiment;

FIG. 10 depicts a flowchart of a process for identifying the interface on which to transmit the message in accordance with an illustrative embodiment; and

FIG. 11 depicts a flowchart of an additional process for transmitting a message over a network in accordance with an illustrative embodiment.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

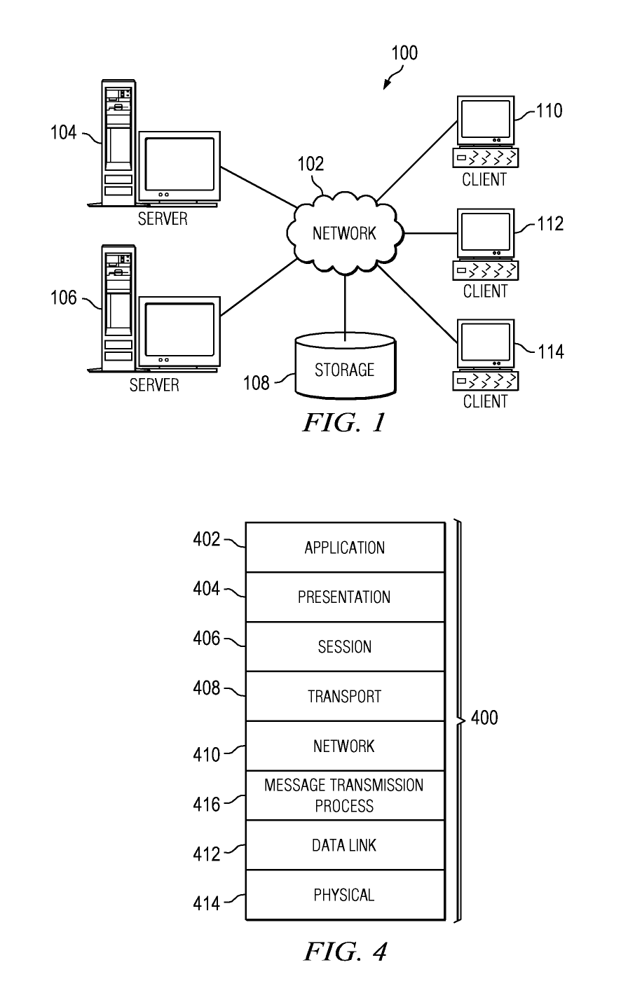

With reference now to the figures and in particular with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation, for the different illustrative embodiments.

Computers in network data processing system 100, such as client computer 110 and server computer 104, implement illustrative embodiments to transmit messages over network 102. For example, client computer 110 may run software that generates messages to transmit over network 102 to another computer system, such as server computer 106. In these examples, at least one protocol is implemented on network 102 such that each computer system connected to network 102 assigns a zone identifier to the interface connected to network 102. The zone identifier may not be unique on network 102. For example, client computer 112 may assign a zone identifier of 1 to the interface connected to network 102, and server computer 104 may also assign a zone identifier of 1 to the interface connected to network 102. However, client computer 114 may assign a zone identifier of 2 to the interface connected to network 102. For example, client computer 114 may contain another interface connected to another network that has a zone identifier of 1.

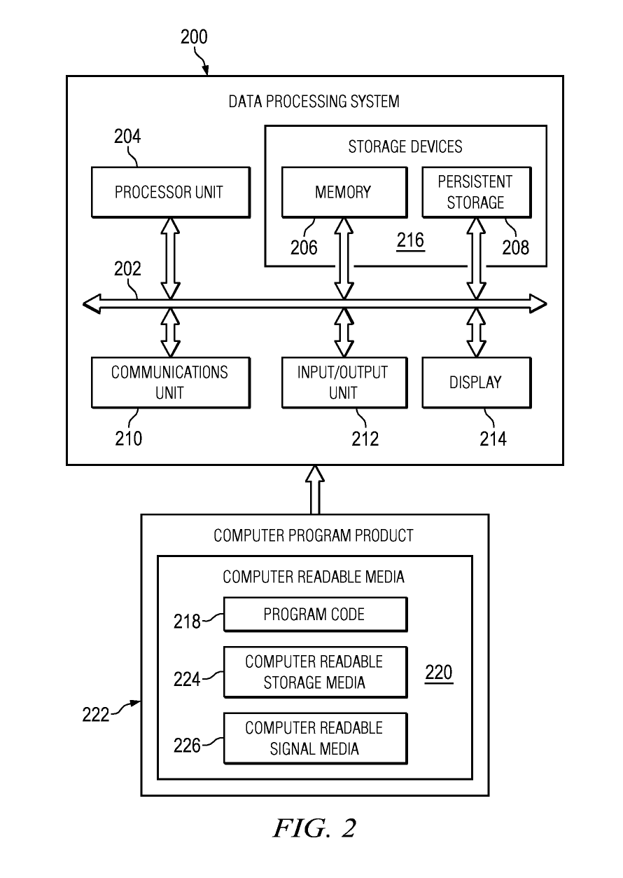

Turning now to FIG. 2, a diagram of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214. Data processing system 200 is an example implementation of server computers 104 and 106, as well as client computers 110, 112 and 114 in FIG. 1.

Processor unit 204 serves to execute instructions for software that may be loaded into memory 206. Processor unit 204 may be a number of processors, may be a multi-processor core, or some other type of processor, depending on the particular implementation. A “number”, as used herein, with reference to an item, means “one or more items”. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disc that is inserted or placed into a drive or other device that is part of persistent storage 208 for transfer onto a storage device, such as a hard drive that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200. In these illustrative examples, computer readable storage media 224 is a non-transitory computer readable storage media.

Alternatively, program code 218 may be transferred to data processing system 200 using computer readable signal media 226. Computer readable signal media 226 may be, for example, a propagated data signal containing program code 218. For example, computer readable signal media 226 may be an electro-magnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, the data processing system may include organic components integrated with inorganic components, and/or may be comprised entirely of organic components, excluding a human being. For example, a storage device may be comprised of an organic semiconductor.

As another example, a storage device in data processing system 200 is any hardware apparatus that may store data. Memory 206, persistent storage 208 and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202.

The different illustrative embodiments recognize and take into account a number of considerations. For example, the different illustrative embodiments recognize and take into account that applications running on computer systems may not have information about the zone identifier for the interface from which messages generated by the applications should be transmitted. Alternatively, the applications may only have information about the interface from which the messages should be transmitted.

In order to get information about zone identifiers and/or use zone identifiers when generating messages to be transmitted on a particular network or interface, costly modification of the kernel of the operating system on which the application is running is performed. An application programming interface that supports receiving zone identifiers is added to the kernel, and message routing software is modified to support receiving zone identifiers. Additionally, the application is also modified to support presenting information that includes zone identifiers and/or using zone identifiers for messages generated by the application. In some examples, the application is also modified to generate requests for information about the zone identifiers available on the computer system. Such modifications are time and cost intensive.

The different illustrative embodiments recognize and take into account that the applications may provide a portion of the source address for the interface from which the messages should be transmitted, along with the destination address for the messages. The computer system identifies the interface from which the messages should be transmitted by identifying an interface that has a source address matching the portion of the desired source address provided by the applications. Additionally, the computer system may store a data source containing collections of interfaces that are grouped together by zone identifier and/or scope. Scope is a range of addresses on a network reachable by a particular interface.

Thus, the different illustrative embodiments provide a method, computer program product, and apparatus for transmitting a message over a network. A processor unit receives the message for transmission over the network and a portion of an address for a source from which the message is to be transmitted. The processor unit identifies an interface configured to transmit messages from the source onto the network using the portion of the address. The processor unit then transmits the message from the source onto the network using the interface.

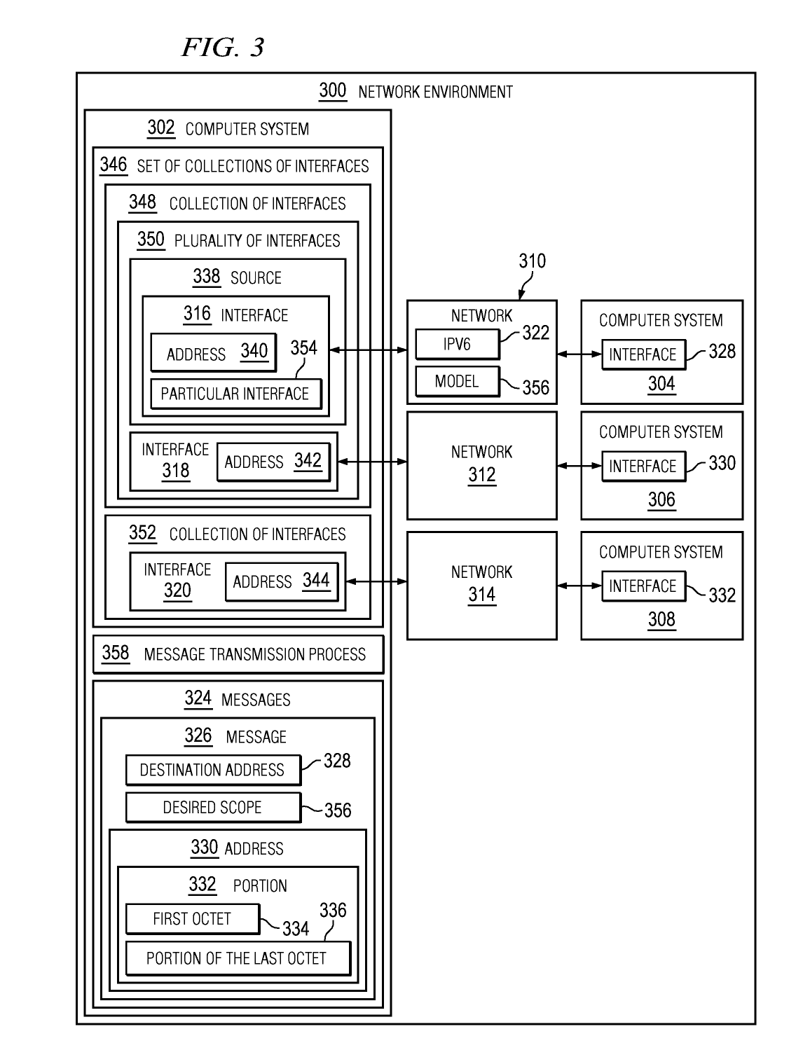

Turning now to FIG. 3, an illustration of a network environment is depicted in accordance with an illustrative embodiment. Network environment 300 is an example of an environment in which illustrative embodiments may be implemented.

Network environment 300 contains computer system 302, computer system 304, computer system 306, computer system 308, network 310, network 312, and network 314. Computer systems 302, 304, 306, and 308 are example implementations of data processing system 200 in FIG. 2. Computer system 304 is associated with interface 328, computer system 306 is associated with interface 330, and computer system 308 is associated with interface 332. Thus, computer system 304 may communicate with computer system 302 using network 310. Computer system 306 may communicate with computer system 302 using network 312. Additionally, computer system 308 may communicate with computer system 302 using network 314.

Networks 310, 312, and 314 are examples of implementations of network 102 in FIG. 1. Networks 310, 312, and 314 each implement a set of protocols. For example, network 310 implements IPv6 322. Network 310 also implements model 356. Implementing model 356 means that network 310 is designed to meet a collection of network architecture standards. As used herein, a collection of objects is one or more of the object. For example, a collection of network architecture standards means one or more network architecture standards. For example, model 356 may be the Open System Interconnection (OSI) model. In these examples, networks 312 and 314 implement the same set of protocols as network 310, as well as model 356. However, networks 310, 312 and 314 are only presented as examples and are not intended as an architectural limitations to the manner in which different illustrative embodiments may be implemented. For example, networks 310, 312, and 314 may implement different protocols in other illustrative embodiments.

In these examples, interface 316, interface 318, and interface 320 are connected to computer system 302 such that computer system 302 may communicate with interfaces 316, 318, and 320 using a communications fabric, such as communications fabric 202 in FIG. 2. Interface 316 is an example implementation of communications unit 210 in FIG. 2. Interface 316 is a network interface that connects computer system 302 to network 310. Interface 316 is addressed on network 310 as address 340. Interface 316 being addressed on network 310 as address 340 means that communications directed to address 340 are received by computer system 302 through interface 316. Additionally, communications transmitted by computer system 302 are designated as being transmitted by computer system 302 at address 340.

Likewise, interface 318 is a network interface that connects computer system 302 to network 312. Interface 318 is addressed on network 312 with address 342. Interface 320 is a network interface that connects computer system 302 to network 314. Interface 320 is addressed on network 314 with address 344. In these examples, networks 310, 312, and 314 are separate networks. For example, an interface connected to network 310 may not transmit a message to a computer system 306 or computer system 308 because computer systems 306 and 308 are not connected to network 310.

Message transmission process 358 is a process running on computer system 302. Message transmission process 358 receives messages 324 for transmission on a network using an interface connected to computer system 302. Messages 324 are data communications for other computer systems, such as computer systems 304, 306, and 308. Messages 324 may be generated by computer system 302 as a result of running software. For example, messages 324 may be hypertext transfer protocol (HTTP) requests.

Message 326 is a message among messages 324 to be transmitted on a network. For example, message 326 may be an HTTP request. Message 326 contains destination address 328 and address 330. Destination address 328 is the address to which message 326 is addressed. Because network 310, network 312, and network 314 are separate networks, message 326 may not be received by the intended computer system at destination address 328 if message 326 is not transmitted on the appropriate interface.

Thus, message 326 also includes address 330. Address 330 is portion 332 of the desired interface to perform the transmission of message 326. Portion 332 may be any combination of first octet 334 of address 330, portion of the last octet 336, or another suitable portion of address 330. In other words, portion 332 is at least a part of the network address of the interface connected to computer system 302 desired to transmit message 326. In these examples, portion 332 consists of first octet 334 and portion of the last octet 336. For example, portion 332 may be fe80::2.

After message 326 is generated, message transmission process 358 identifies source 338 from which to transmit message 326. Source 338 is a network interface connected to the same network as the interface with the address described by portion 332. In other words, source 338 is the network interface connected to the desired network for transmitting message 326. In some illustrative embodiments, message transmission process 358 identifies the interface connected to computer system 302 that has an address that matches portion 332.

For example, assume networks 310, 312, and 314 use IPv6 322 as a protocol. Assume address 340 is fe80::1. Addresses in IPv6 322 that contain octets of zeroes may be abbreviated as “::” in writing. Thus, fe80::1 is a representation of the IPv6 322 address of fe80:0:0:0:0:0:0:1. Likewise, assume address 342 is fe80::22 and address 344 is fe80::43. Now, assume portion 332 is 1. Computer system 302 processes addresses 340, 342, and 344 and identifies address 340 as containing first octet 334 and portion of the last octet 336 provided in portion 332. Computer system then transmits message 326 to destination address 328 using interface 316.

In other illustrative embodiments, however, multiple interfaces connected to computer system 302 are connected to one network. Multiple interfaces may be connected to one network to provide load balancing and/or as a backup in the event an interface experiences inconsistencies. In such illustrative embodiments, computer system 302 contains set of collections of interfaces 346. As used herein, a set means one or more of the particular item. Thus, a set of collections of interfaces is one or more of a collection of interfaces. Set of collections of interfaces 346 consists of groups of interfaces connected to computer system 302. Each of the groups of interfaces are a particular collection of interfaces 348 in these examples.

Each of collection of interfaces 348 consists of the interfaces connected to a particular network and having a particular scope. Scope is a range of addresses that may be contacted by a particular interface on a particular network. In other words, each of collection of interfaces 348 is a set of interfaces connected to computer system 302 that are connected to the same network and have a particular scope. For example, assume that interface 318 is not connected to network 312, but connected to network 310. In such an illustrative example, a first collection of interfaces 348 in set of collections of interfaces 346 would contain interface 316 and interface 318. On the other hand, interface 320 is in collection of interfaces 352 because interface 320 is connected to network 314 and not network 310.

In the illustrative embodiments, when message 326 is generated, message transmission process 358 processes set of collections of interfaces 346 by identifying an address for an interface in set of collections of interfaces 346 that at least partially matches portion 332. Once the interface with the address that at least partially matches portion 332 is identified, message transmission process 358 identifies plurality of interfaces 350. Plurality of interfaces 350 consists of the interfaces in collection of interfaces 348 containing the interface with the address that at least partially matches portion 332 to form particular interface 354. Message transmission process 358 then identifies an interface in plurality of interfaces 350 on which to transmit message 326 and transmits message 326. Message transmission process 358 identifies an interface in plurality of interfaces 350 on which to transmit message 326 using a set of predetermined rules. For example, the rules may indicate that message transmission process 358 is to use a different interface than particular interface 354 that has an address that differs from portion 332.

For example, assume networks 310, 312, and 314 use IPv6 322 as a protocol. Assume address 340 is fe80::1. Addresses in IPv6 322 that contain octets of zeroes may be abbreviated as “::” in writing. Thus, fe80::1 is a representation of the IPv6 322 address of fe80:0:0:0:0:0:0:1. Likewise, assume address 342 is fe80::22 and address 344 is fe80::43. Also assume that interface 316 and interface 318 are in collection of interfaces 348 because both interface 316 and interface 318 are connected to network 310 and neither is connected to network 312. Interface 320 is in collection of interfaces 348. Now, assume message 326 is generated with portion 332 being 1.

In such an illustrative example, message transmission process 358 processes set of collections of interfaces 346 by identifying which interface in set of collections of interfaces 346 has an address at least partially matching portion 332 of 1. In this illustrative example, interface 316 has address 340 of fe80::1 and matches portion 332 in part. In response, message transmission process 358 identifies collection of interfaces 348 containing interface 316 and interface 318 to form plurality of interfaces 350. Message transmission process 358 then selects an interface from plurality of interfaces 350 to transmit message 326. In this illustrative example, pre-determined rules indicate that message transmission process 358 is to use interface 318 to transmit message 326 because interface 318 has a faster link than interface 316. Computer system 302 then transmits message 326 on interface 318.

In some illustrative embodiments, message 326 also contains desired scope 356. A scope is a topological region of a network on which a particular address is unique and usable by an interface. Desired scope 356 is the range of addresses in which destination address 328 is located. For example, desired scope 356 may be a link-local scope in a network using IPv6 322. In such illustrative embodiments, set of collections of interfaces also identifies a particular scope for each collection of interfaces, such as collection of interfaces 348 and collection of interfaces 352. Message transmission process 358 then identifies collection of interfaces 348 that both contains particular interface 354 and has desired scope 356.

The illustration of computer system 302 in network environment 300 is not meant to imply physical or architectural limitations to the manner in which different features may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, computer system 302 may have additional or fewer interfaces. Computer system 302 may also have multiple interfaces connected to one network. Network 310, network 312, and network 314 may use the same protocols, some of the same protocols, or none of the same protocols. In some illustrative embodiments, message 326 contains desired scope 356; however, in other illustrative embodiments, message 326 does not contain desired scope 356. In such illustrative embodiments, computer system 302 may identify collection of interfaces 348 that has an appropriate scope for destination address 328.

Turning now to FIG. 4, an illustration of an Open System Interconnection (OSI) model is illustrated in accordance with an illustrative embodiment. Model 400 is an example implementation of model 356 in FIG. 3. In these examples, model 400 is the Open System Interconnection (OSI) model. Each layer in model 400 provides services to the next layer above the layer. Illustrative embodiments are implemented in various sections of model 400.

Application layer 402 is the layer used by software applications to communicate with software applications running on other computer systems that use the same protocol. Application layer 402 is the highest layer in model 400 and messages in this layer may not contain information about services provided by lower levels. For example, domain name system (DNS) and file transfer protocol (FTP) messages are transmitted in application layer 402.

Presentation layer 404 maps data to a syntax and semantics understood by an application communicating on application layer 402. The syntax and semantics may be different for the sender and receiver. For example, each of the sender and receiver may use different systems of encryption and decryption that are hidden from application layer 402 such that the encryption and decryption is not performed by application layer 402.

Session layer 406 is a layer used to open and close sessions between senders and receivers. A session is a series of communications that are stateful. In other words, the messages in a session are associated such that the receiving computer system may use data from previous messages in processing the current message. Sessions are also used in reestablishing lost connections between computer systems.

Transport layer 408 is the layer in which data is encapsulated into segments of a particular size. Transport layer 408 also establishes flow control on a connection. Flow control is a system in which the recipient of a message communicates to the sender when the receiving computer system is ready to receive additional messages. One example of a transport layer 408 protocol is transport control protocol (TCP).

Network layer 410 is the layer in which messages are analyzed to determine whether the messages are destined for the receiving computer system by analyzing the destination address of the messages. The destination address of incoming messages addressed to the receiving computer system is an example implementation of address 342 in FIG. 3. In other words, the destination address of a received message addressed to the receiving interface is also the outgoing address of that interface. Network layer 410 is also the layer in which a source address, such as address 340, and destination addresses, such as destination address 328, are inserted into outgoing messages by message transmission process 416. Message transmission process 416 is an example implementation of message transmission process 358 in FIG. 3. For example, Internet Protocol (IP) addresses are attached and detached from messages at network layer 410.

Data link layer 412 is the layer in which physical addressing of interfaces occurs. Incoming packets are analyzed to determine whether the destination address of the incoming messages is the same as the physical address of the interface. The physical address differs from the address on network layer 410 in that messages addressed to a particular physical address are not relayed by routers. In other words, a physical address may only be reached by an interface when a router does not separate the two interfaces on the network. An illustrative example of physical addressing is media access control (MAC) addresses.

Physical layer 414 is the layer at which signals are transmitted and received on the network media. The network media is the physical connection between the devices on the network. For example, the network media may be Ethernet, Bluetooth, Infrared, Firewire, or another suitable medium.

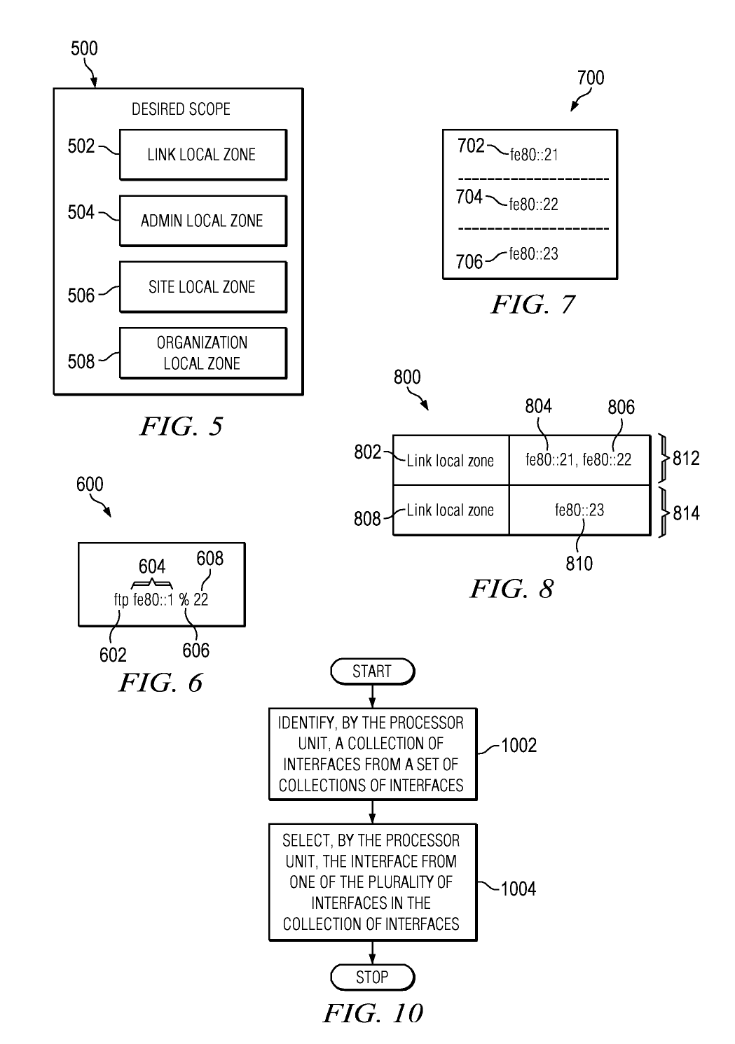

Turning now to FIG. 5, an illustration of a desired scope is illustrated in accordance with an illustrative embodiment. Desired scope 500 is an example implementation of desired scope 356 in FIG. 3. Desired scope 500 is the range of addresses with which the transmitting interface should be able to communicate to deliver a message, such as message 326, to the destination address.

In illustrative embodiments in which IPv6 is used on the network, desired scope 500 may be link local zone 502, admin local zone 504, site local zone 506, or organization local zone 508. Of course, other desired scopes 500 may be used in the message. Link local zone 502 allows the message to reach interfaces that are connected to the same network as the transmitting interface but not separated from the transmitting interface by a router.

Admin local zone 504, site local zone 506, and organization local zone 508 are address scopes that are configurable by a human. The scopes are not limited to particular segments of a network beyond being assigned to a particular organization. Different organizations configure admin local zone 504, site local zone 506, and organization local zone 508 in different ways.

Turning now to FIGS. 6-8, two examples of transmitting a message over a network are depicted. FIG. 6 is an illustrative example of an input that causes a message to be generated by a computer system. FIG. 7 is an illustrative example of the interfaces connected to the computer system from which the computer system identifies the particular interface from which to transmit the message illustrated in FIG. 6. FIG. 8 is a different illustrative example of a set of collections of interfaces from which the computer system identifies a plurality of interfaces and selects an interface from the plurality of interfaces to transmit the message.

Looking specifically to FIG. 6, an illustration of an input that causes a message to be generated by a computer system is depicted in accordance with an illustrative embodiment. The message generated by entering input 600 into a computer system is an example implementation of message 326 in FIG. 3.

Input 600 consists of application name 602, destination address 604, marker 606, and portion 608. Application name 602 is the name of the application to be run and which generates the message. In this illustrative example, the file transfer protocol (FTP) application is to be run on the computer system. Running the software with the other components of input 600 cause a message to be generated.

Destination address 604 is the interface on the network with which the interface connected to the computer system receiving input 600 is to communicate. In this illustrative example, destination address 604 is fe80::1. Destination address 604 is an example implementation of destination address 328 in FIG. 3. Marker 606 is a syntax identifier that divides destination address 604 from portion 608 in input 600. Portion 608 is at least a part of the desired source address for the message to be generated by input 600. Portion 608 is an example implementation of portion 332 in FIG. 3. In this illustrative example, portion 608 is 22.

Turning now to FIG. 7, an illustration of a listing of interfaces is depicted in accordance with an illustrative embodiment. Listing 700 is a listing of the addresses for all interfaces connected to the computer system. Of course, in some illustrative embodiments, only interfaces connected to a network are contained in listing 700. Listing 700 contains entries 702, 704, and 706. Entry 702 represents an interface with an address of fe80::21. Entry 704 represents an interface with an address of fe80::22. Entry 706 represents an interface with an address of fe80::23.

In response to a message resulting from input 600 being generated, the computer system uses portion 608 to identify the interface in listing 700 that has an address matching portion 608. In this illustrative embodiment, portion 608 represents the last octet of the address of the desired interface. Entry 702 and entry 706 do not contain addresses that at least partially match portion 608. Entry 704 contains such an address. Therefore, the interface associated with the address contained in entry 704 is selected to transmit the message.

Looking now to FIG. 8, an illustration of a set of collections of interfaces from which the computer system identifies a plurality of interfaces is depicted in accordance with an illustrative embodiment. Set of collections of interfaces 800 is an example implementation of set of collections of interfaces 346 in FIG. 3.

Set of collections of interfaces 346 contains collection of interfaces 812 and collection of interfaces 814. Collection of interfaces 812 is an example implementation of collection of interfaces 348, and collection of interfaces 814 is an example implementation of collection of interfaces 352 in FIG. 3. Collection of interfaces 812 has link local zone scope 802, and contains interfaces with addresses 804 and 806. Collection of interfaces 812 contains both addresses 804 and 806 because the interfaces having addresses 804 and 806 are connected to the same network. Collection of interfaces 814 has link local zone scope 808 and contains interfaces having address 810.

In this illustrative embodiment, once the message caused by the running of input 600 is generated, the computer system identifies a collection of interfaces in set of collection of interfaces 800 that contains an interface with an address that at least partially matches portion 608. In this illustrative example, collection of interfaces 812 contains address 806, which is fe80::22. Address 806 matches portion 608 because the last octet in address 806 is 22. The computer system then processes predetermined rules to identify the interface in collection of interfaces 812 from which to transmit the message. Depending on the predetermined rules, either interface with address 804 or interface with address 806 may be selected to transmit the message. The computer system selects the interface and transmits the message using the interface.

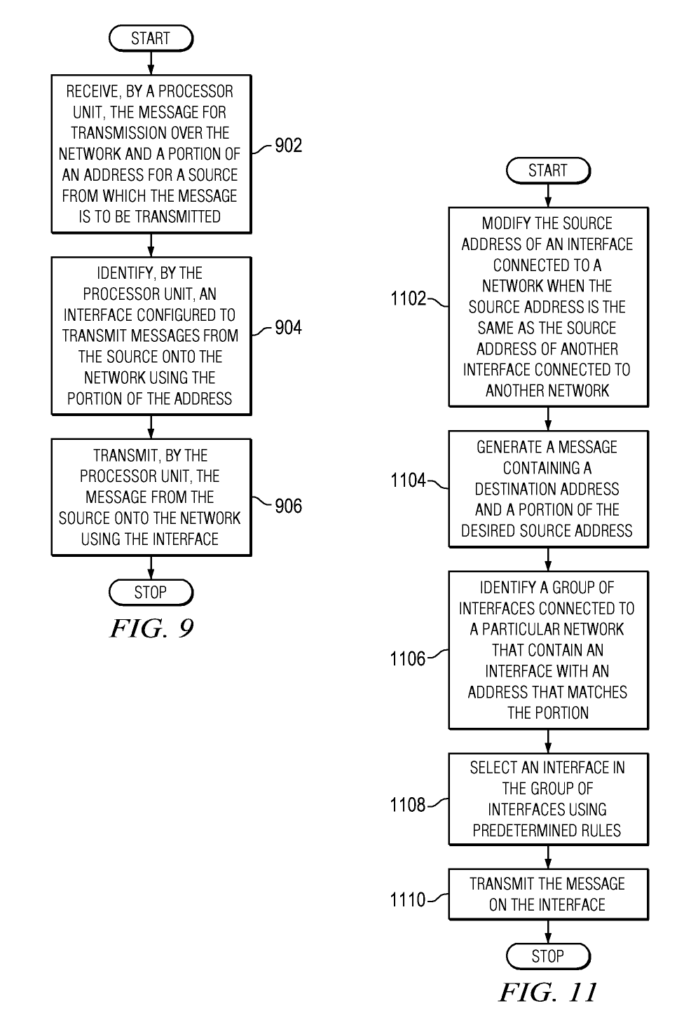

Turning now to FIG. 9, a flowchart of a process for transmitting a message over a network is depicted in accordance with an illustrative embodiment. The process may be implemented in network environment 300 by message transmission process 358 running on computer system 302 in FIG. 3.

The process begins by receiving the message for transmission over the network and a portion of an address for a source from which the message is to be transmitted (step 902). The source is an interface that is connected to the same network to which an interface with an address at least partially matching the portion is connected.

The process then identifies an interface configured to transmit messages from the source onto the network using the portion of the address (step 904). The process may identify the interface by processing a list of the addresses of all interfaces connected to the computer system that are connected to a network and selecting the interface with the address that at least partially matches the portion. Alternatively, the process may perform the steps depicted in FIG. 10 to identify the interface.

The process then transmits the message from the source onto the network using the interface (step 906). The recipient of the message is the interface at the destination address included with the message. The message may be, for example, an HTTP request. The process terminates thereafter.

Looking with specificity to FIG. 10, a process for identifying the interface on which to transmit the message is depicted in accordance with an illustrative embodiment. The process may be implemented in network environment by message transmission process 358 running on computer system 302 in FIG. 3. The process is an example implementation of step 904 in FIG. 9.

The process begins by identifying a collection of interfaces from a set of collection of interfaces (step 1002). The set of collection of interfaces consists of groups of interfaces that are connected to the same network. The collection of interfaces consists of interfaces that include a particular interface associated with the address containing the portion. The process then selects the interface from the plurality of interfaces in the collection of interfaces (step 1004). The process may use predetermined rules to select the interface from the plurality of interfaces. The predetermined rules may be standardized rules. For example, the predetermined rules may be the rules of Internet Society Requests for Comment 3484. The process terminates thereafter.

Turning now to FIG. 11, a flowchart of an additional process for transmitting a message on an interface is depicted in accordance with an illustrative embodiment. The process may be implemented in network environment 300 by message transmission process 358 running on computer system 302 in FIG. 3.

The process begins by modifying the source address of an interface connected to a network when the source address is the same as the source address of another interface connected to another network (step 1102). In some illustrative embodiments, step 1102 is modified only when both source addresses have a scope that is not global. For example, the scope may be link local zone 502, admin local zone 504, site local zone 506, organization local zone 508 in FIG. 5, or another suitable non-global scope. The process then generates a message containing a destination address and a portion of the desired source address (step 1104). The desired source address is the address of the interface connected to the network on which the message should be transmitted. The process then identifies a group of interfaces connected to a particular network that contain an interface with an address that matches the portion (step 1106). The grouping of interfaces may be designated by a user. In illustrative embodiments in which the grouping of interfaces contains the scope of the interfaces, the scope may also be designated by a user.

The process then selects an interface in the group of interfaces using predetermined rules (step 1108). The predetermined rules may be a prioritized list of interfaces for the particular group. The process then transmits the message on the interface (step 1110). The process terminates thereafter.

The flowchart and block diagrams in the different depicted embodiments illustrate the architecture, functionality, and operation of some possible implementations of apparatus and methods in different illustrative embodiments. In this regard, each block in the flowchart or block diagrams may represent a module, segment, function, and/or a portion of an operation or step.

In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved. Also, other blocks may be added in addition to the illustrated blocks in a flowchart or block diagram.

For example, the process may set the addresses of the interfaces connected to the computer system to addresses that are unique to the computer system prior to performing step 902. In other words, the process may modify the address of an interface that has the same address as another interface connected to the computer system. Additionally, the process may not identify a particular group of interfaces in step 1106 if the group of interfaces does not have the scope to deliver the message to the destination address.

Thus, the different illustrative embodiments allow an application to specify a portion of the source address of an interface connected to the network over which the message should be transmitted. The computer system may be connected to multiple networks using different interfaces while applications can communicate on each of them. Additionally, the computer system may select an interface different from the interface with the desired source address when predetermined rules cause the computer system to select another interface connected to the same network as the interface with the source address that at least partially matches the address included with the message.

Thus, the different illustrative embodiments provide a method, computer program product, and apparatus for transmitting a message over a network are presented. A processor unit receives the message for transmission over the network and a portion of an address for a source from which the message is to be transmitted. The processor unit identifies an interface configured to transmit messages from the source onto the network using the portion of the address. The processor unit then transmits the message from the source onto the network using the interface.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for transmitting a message over a network comprising:
receiving, by a processor unit, the message for transmission over the network and a portion of an address for a source from which the message is to be transmitted;
identifying, by the processor unit, an interface configured to transmit messages from the source onto the network using the portion of the address; and
transmitting, by the processor unit, the message from the source onto the network using the interface.

2. The method of claim 1, wherein the interface is a first interface, and wherein the step of identifying the interface on which to transmit the message comprises:
identifying, by the processor unit, a collection of interfaces from a set of collections of interfaces, wherein the collection of interfaces has a plurality of interfaces that includes a particular interface associated with the address containing the portion; and
selecting, by the processor unit, the interface from the plurality of interfaces in the collection of interfaces.

3. The method of claim 2, wherein the collection of interfaces are identified using a desired scope for the message.

4. The method of claim 3 further comprising:
prior to identifying the collection of interfaces from the set of collections of interfaces, identifying, by the processor unit, the desired scope for the message using a portion of the destination address for the message.

5. The method of claim 1, wherein the network is an internet protocol version 6 network.

6. The method of claim 1, wherein the step of identifying the interface on which to transmit the message is performed when a destination address for the message is in a desired scope selected from a group comprising a link local zone, an admin local zone, a site local zone, and an organization local zone.

7. The method of claim 1, wherein the portion of the address comprises a first octet and at least a portion of a last octet of the address.

8. A computer program product comprising:
a computer readable storage medium;
program code, stored on the computer readable storage medium, for receiving, by a processor unit, the message for transmission over the network and a portion of an address for a source from which the message is to be transmitted;
program code, stored on the computer readable storage medium, for identifying, by the processor unit, an interface configured to transmit messages from the source onto the network using the portion of the address;
program code, stored on the computer readable storage medium, for transmitting, by the processor unit, the message from the source onto the network using the interface.

9. The computer program product of claim 8, wherein the interface is a first interface, and wherein the program code for identifying the interface on which to transmit the message comprises:
program code, stored on the computer readable storage medium, for identifying, by the processor unit, a collection of interfaces from a set of collections of interfaces, wherein the collection of interfaces has a plurality of interfaces that includes a particular interface associated with the address containing the portion; and
program code, stored on the computer readable storage medium, for selecting, by the processor unit, the interface from the plurality of interfaces in the collection of interfaces.

10. The computer program product of claim 9, wherein the collection of interfaces are identified using a desired scope for the message.

11. The computer program product of claim 10 further comprising:
program code, stored on the computer readable storage medium, for, prior to identifying the collection of interfaces from the set of collections of interfaces, identifying, by the processor unit, the desired scope for the message using a portion of the destination address for the message.

12. The computer program product of claim 8, wherein the network is an internet protocol version 6 network.

13. The computer program product of claim 8, wherein the program code for of identifying the interface on which to transmit the message is run when a destination address for the message is in a desired scope selected from a group comprising a link local zone, an admin local zone, a site local zone, and an organization local zone.

14. The computer program product of claim 8, wherein the portion of the address comprises a first octet and at least a first portion of a last octet of the address.

15. An apparatus comprising:
a bus system;
an interface connected to the bus system, wherein the interface is connected to a network and is configured to communicate using the network;
a storage device connected to the bus system, wherein the storage device includes program code; and
a processor unit connected to the bus system, wherein the processing unit executes the program code to receive the message for transmission over the network and a portion of an address for a source from which the message is to be transmitted, identify an interface configured to transmit messages from the source onto the network using the portion of the address, and transmit the message from the source onto the network using the interface.

16. The apparatus of claim 15, wherein the interface is a first interface, and wherein the processor unit being configured to identify the interface configured to transmit messages from the source onto the network using the portion of the address further comprises:
the processor unit being configured to identify a collection of interfaces from a set of collections of interfaces, wherein the collection of interfaces has a plurality of interfaces that includes a particular interface associated with the address containing the portion; and
the processor unit being configured to select the interface from the plurality of interfaces in the collection of interfaces.

17. The apparatus of claim 16, wherein the collection of interfaces are identified using a desired scope for the message.

18. The apparatus of claim 17 further comprising:
the processor unit being configured to, prior to identifying the collection of interfaces from the set of collections of interfaces, identify the desired scope for the message using a portion of the destination address for the message.

19. The apparatus of claim 15, wherein the network is an internet protocol version 6 network.

20. The apparatus of claim 15, wherein the interface on which to transmit the message is identified when a destination address for the message is in a desired scope selected from a group comprising a link local zone, an admin local zone, a site local zone, and an organization local zone.
